(19) United States
(12) Patent Application Publication
(10) Pub. No.: US 2021/0276913 A1
(43) Pub. Date: Sep. 9, 2021

(54) METHOD FOR FORMING GLASS-CERAMIC ARTICLES AND GLASS-CERAMIC ARTICLES FORMED THEREFROM

(71) Applicant: CORNING INCORPORATED, CORNING, NY (US)

(72) Inventors: Indrajit Dutta, Horseheads, NY (US); Mathieu Gerard Jacques Hubert, Corning, NY (US); Timothy James Kiczenski, Corning, NY (US); Marion Novitovic-Dunn, Corning, NY (US)

(21) Appl. No.: 17/049,600

(22) PCT Filed: Apr. 18, 2019
(86) PCT No.: PCT/US2019/028075

§ 371 Date: Oct. 22, 2020

Related U.S. Application Data
(60) Provisional application No. 62/661,830, filed on Apr. 24, 2018.

(51) Int. Cl. C03B 32/02; C03C 4/02

(52) U.S. Cl. CPC C03B 32/02; C03C 4/02

(57) ABSTRACT

A process for making a glass-ceramic article includes annealing an as-formed glass article formed from a glass-ceramic composition at a first temperature for a duration sufficient to nucleate a plurality of nuclei within a vitreous matrix of the as-formed glass article and forming a post-nucleation glass article. The process also includes annealing the post-nucleation glass article at a second temperature for a duration sufficient to grow crystalline grains within the vitreous matrix of the post-nucleation glass article and forming a glass-ceramic article. The first temperature is less than a glass transition temperature for the glass-ceramic composition and the second temperature is greater than the glass transition temperature for the glass-ceramic composition.

### CROSS-REFERENCE TO RELATED APPLICATIONS

This application claims the benefit of priority under 35 U.S.C. § 119 of U.S. Provisional Application No. 62/661,830, filed Apr. 24, 2018, the content of which is incorporated herein by reference in its entirety.

### BACKGROUND

### Field

The present specification generally relates to a method of forming a glass-ceramic article and, more specifically, a method of forming a glass-ceramic article by annealing a glass-ceramic composition at a temperature below the glass transition temperature for the glass-ceramic composition.

### Technical Background

Glass-ceramics are microcrystalline solids produced by the controlled devitrification of glass. A glass-ceramic composition is melted, fabricated to a desired shape, and then converted by heat treatment to a predominantly crystalline ceramic. Controlled crystallization of the glass-ceramic composition includes efficient internal nucleation of nuclei within a vitreous matrix which allows for the growth of fine, randomly oriented crystalline grains without voids, microcracks, or other porosity within the glass-ceramic microstructure. The combination of the crystalline grains within the vitreous matrix provide a material with a chemical stability of glass and thermal mechanical properties of ceramics. Particularly, glass-ceramics are resistant to corrosion, scratch resistant, mechanically strong and can sustain repeated and quick temperature changes without failure. The crystalline grains can also diffuse and reflect light such that glass-ceramics can be formed to exhibit different colors. Such a combination of properties has resulted in the successful development of numerous commercial products such as stove-top surfaces, cookware, optical wave guides, telescope mirrors, bone prosthesis, dental restorations, decorative furnishings, art work, etc.

### SUMMARY

One embodiment for making a glass-ceramic includes annealing a glass-ceramic composition at a first temperature for a duration sufficient to nucleate a plurality of nuclei within a vitreous matrix of the glass-ceramic composition, and annealing the glass-ceramic composition at a second temperature for a duration sufficient to grow crystalline grains within the vitreous matrix. The first temperature is less than a glass transition temperature for the glass-ceramic composition and the second temperature is greater than the glass transition temperature for the glass-ceramic composition. In embodiments, the first temperature is at least 25° C. less than the glass transition temperature for the glass-ceramic composition, for example, at least 50° C. or at least 100° C. less than the glass transition temperature for the glass-ceramic composition. The glass-ceramic composition may be annealed at the first temperature for less than 8 hours, for example less than 6 hours. In embodiments, the glass-ceramic chemical composition, comprises Li₂O, Al₂O₃, SiO₂, and Fe₂O₃ with a glass transition temperature between about 590° C. and about 610° C. In such embodiments, the first temperature may be less than 550° C., for example less than 500° C. or less than 450° C. The viscosity of the glass article at the first temperature may be equal to or greater than 1×10¹³ poise and the viscosity of the glass article at the second temperature may be less than 1×10¹³ poise. In some embodiments, the viscosity of the glass article at the first temperature is greater than or equal to 5.0×10¹³ poise, for example greater than or equal to 1.0×10¹⁴ poise.

In some embodiments, a method of forming a glass-ceramic article and glass-ceramic articles formed therefrom may include the following features.

Feature 1. A method for making a glass-ceramic article from a glass-ceramic composition, the process comprising:
annealing an as-formed glass article comprising a glass-ceramic composition at a first temperature for a duration sufficient to nucleate a plurality of nuclei within a vitreous matrix of the glass-ceramic composition and forming a post-nucleation glass article; and
annealing the post-nucleation glass article at a second temperature for a duration sufficient to grow crystalline grains within the vitreous matrix of the post-nucleation glass article and forming a glass-ceramic article;
wherein the first temperature is less than a glass transition temperature for the glass-ceramic composition and the second temperature is greater than the glass transition temperature for the glass-ceramic composition.

Feature 2. The method of feature 1 above, wherein the first temperature is at least 25° C. less than the glass transition temperature for the glass-ceramic composition.

Feature 3. The method of feature 1 above, wherein the first temperature is at least 50° C. less than the glass transition temperature for the glass-ceramic composition.

Feature 4. The method of feature 1 above, wherein the first temperature is at least 100° C. less than the glass transition temperature for the glass-ceramic composition.

Feature 5. The method of feature 1 above, wherein a viscosity of the glass-ceramic composition is equal to or greater than 10¹³ poise at the glass transition temperature.

Feature 6. The method of feature 1 above, wherein the glass-ceramic composition comprises a chemical composition comprising Li₂O, Al₂O₃, SiO₂, and Fe₂O₃, and has a glass transition temperature between about 590° C. and about 610° C.

Feature 7. The method of feature 6 above, wherein the first temperature is less than 550° C.

Feature 8. The method of feature 6 above, wherein the first temperature is less than 500° C.

Feature 9. The method of feature 6 above, wherein the first temperature is less than 450° C.

Feature 10. The method of feature 1 above, wherein the as-formed glass article is annealed at the first temperature for less than 8 hours.

Feature 11. The method of feature 1 above, wherein the as-formed glass article is annealed at the first temperature for less than 6 hours.

Feature 12. The method of feature 1 above, wherein a viscosity of the as-formed glass article at the first temperature is equal to or greater than 1.0×10¹³ poise and the viscosity of the post-nucleation glass article at the second temperature is less than 1.0×10¹³ poise.

Feature 13. The method of feature 12 above, wherein the viscosity of the as-formed glass article at the first temperature is greater than or equal to 5.0×10¹³ poise.

Feature 14. The method of feature 12 above, wherein the viscosity of the as-formed glass article at the first temperature is greater than or equal to 1.0×10¹⁴ poise.

Feature 16. A glass-ceramic article prepared by a process comprising:
annealing an as-formed glass article formed from a glass-ceramic composition comprising a chemical composition comprising Li₂O, Al₂O₃, SiO₂, and Fe₂O₃ at a first temperature such that a plurality of nuclei nucleate within a vitreous matrix of the as-formed glass article and form a post-nucleation glass article;
annealing the post-nucleation glass article at a second temperature such that crystalline grains grow within the vitreous matrix of the post-nucleation glass article and form the glass-ceramic glass article;
wherein the first temperature is less than a glass transition temperature for the glass-ceramic composition and the second temperature is greater than the glass transition temperature for the glass-ceramic composition.

Additional features and advantages will be set forth in the detailed description which follows, and in part will be readily apparent to those skilled in the art from the description or recognized by practicing the embodiments as described in the written description and claims hereof, as well as the appended drawings.

It is to be understood that both the foregoing general description and the following detailed description are merely exemplary, and are intended to provide an overview or framework to understand the nature and character of the claims. The accompanying drawings are included to provide a further understanding, and are incorporated in and constitute a part of this specification. The drawings illustrate one or more embodiments, and together with the description serve to explain principles and operation of the various embodiments.

### BRIEF DESCRIPTION OF THE DRAWINGS

FIG. 1 schematically depicts a method of forming glass-ceramics according to one or more embodiments described herein;

FIG. 2(a) graphically depicts temperature as a function of position within a gradient tube furnace used to form a glass-ceramic according to one or more embodiments described herein;

FIG. 2(b) is a photograph of a strip of as-formed glass strip before being annealed to form a glass-ceramic strip;

FIG. 2(c) is a photograph of a post-nucleation glass strip formed from the as-formed glass strip in FIG. 2(b) by annealing in a gradient furnace at temperatures between about 450° C. and about 800° C. for a duration of 2.25 hours;

FIG. 2(d) is a photograph of a glass-ceramic strip formed from the post-nucleation glass strip in FIG. 2(c) by isothermally annealing at 760° C. for 6 hours;

FIG. 3 is a photograph of a glass-ceramic strip and six glass-ceramic panels after being annealed at different first temperatures between about 450° C. and 800° C. for a duration of 3.25 hours, and isothermally annealed at a second temperature of 760° C. for 6 hours;

FIG. 4 is a photograph of a glass-ceramic strip and six glass-ceramic panels after being annealed at different first temperatures between about 450° C. and 800° C. for a duration of 3.25 hours, and isothermally annealed at a second temperature of 760° C. for 6 hours; and

FIG. 5 is a photograph of a glass-ceramic strip and six glass-ceramic panels after being annealed at different first temperatures between about 450° C. and 800° C. for a duration of 3.25 hours, and isothermally annealed at a second temperature of 760° C. for 6 hours.

### DETAILED DESCRIPTION

In the following detailed description, numerous specific details may be set forth in order to provide a thorough understanding of embodiments of the invention. However, it will be clear to one skilled in the art when embodiments of the invention may be practiced without some or all of these specific details. In other instances, well-known features or processes may not be described in detail so as not to unnecessarily obscure the invention. Moreover, unless otherwise defined, all technical and scientific terms used herein have the same meaning as commonly understood by one of ordinary skill in the art to which this invention belongs. In case of conflict, the present specification, including the definitions herein, will control.

Although other methods and can be used in the practice or testing of the invention, certain suitable methods and materials are described herein.

Disclosed are materials, compounds, compositions, and components that can be used for, can be used in conjunction with, can be used in preparation for, or are embodiments of the disclosed method and compositions. These and other materials are disclosed herein, and it is understood that when combinations, subsets, interactions, groups, etc. of these materials are disclosed that while specific reference of each various individual and collective combinations and permutation of these compounds may not be explicitly disclosed, each is specifically contemplated and described herein.

Thus, if a class of substituents A, B, and C are disclosed as well as a class of substituents D, E, and F, and an example of a combination embodiment, A-D is disclosed, then each is individually and collectively contemplated. Thus, in this example, each of the combinations A-E, A-F, B-D, B-E, B-F, C-D, C-E, and C-F are specifically contemplated and should be considered disclosed from disclosure of A, B, and/or C; D, E, and/or F; and the example combination A-D. Likewise, any subset or combination of these is also specifically contemplated and disclosed. Thus, for example, the sub-group of A-E, B-F, and C-E are specifically contemplated and should be considered disclosed from disclosure of A, B, and/or C; D, E, and/or F; and the example combination A-D. This concept applies to all aspects of this disclosure including, but not limited to any components of the compositions and steps in methods of making and using the disclosed compositions. More specifically, the example composition ranges given herein are considered part of the specification and further, are considered to provide example numerical range endpoints, equivalent in all respects to their specific inclusion in the text, and all combinations are specifically contemplated and disclosed. Further, if there are a variety of additional steps that can be performed it is understood that each of these additional steps can be performed with any specific embodiment or combination of embodiments of the disclosed methods, and that each such combination is specifically contemplated and should be considered disclosed.

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. In general, an amount, size, formulation, parameter or other quantity or characteristic is “about” or “approximate” whether or not expressly stated to be such.

The term “or”, as used herein, is inclusive; more specifically, the phrase “A or B” means “A, B, or both A and B.” Exclusive “or” is designated herein by terms such as “either A or B” and “one of A or B,” for example.

The indefinite articles “a” and “an” are employed to describe elements and components of the invention. The use of these articles means that one or at least one of these elements or components is present. Although these articles are conventionally employed to signify that the modified noun is a singular noun, as used herein the articles “a” and “an” also include the plural, unless otherwise stated in specific instances. Similarly, the definite article “the”, as used herein, also signifies that the modified noun may be singular or plural, again unless otherwise stated in specific instances.

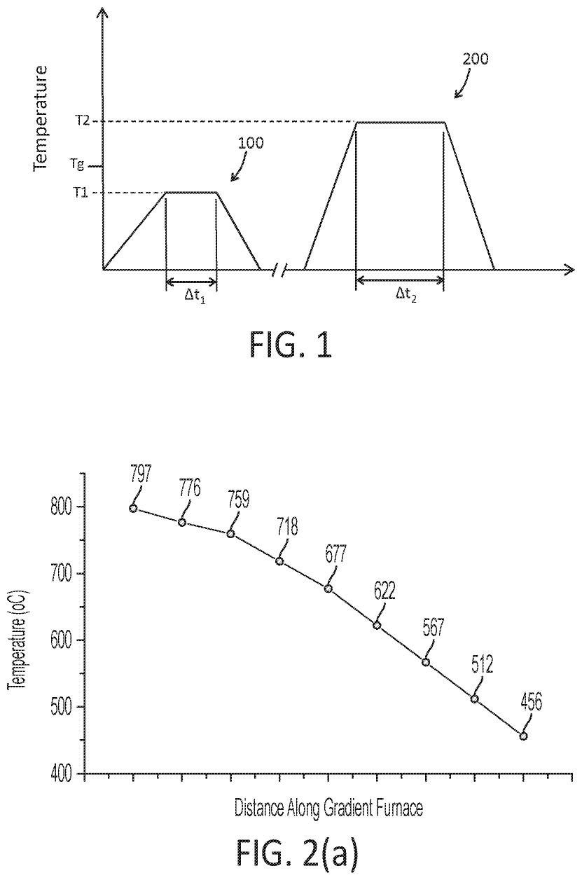

Referring to FIG. 1, a time versus temperature diagram for a method of forming a glass-ceramic article is schematically depicted. The process includes annealing an as-formed glass article in a first annealing step 100 and a second annealing step 200. As used herein, the term “as-formed glass” refers to a glass with a glass-ceramic composition that has been formed into an article (e.g., strip) but has not been annealed with the first annealing step (nucleation) or the second annealing step (grain growth) described herein. The as-formed glass article is formed from a glass-ceramic composition and has a vitreous matrix. The first annealing step 100 includes heating the as-formed glass article, or a portion of the as-formed glass article, to a first temperature (T1) and holding the glass article at the first temperature T1 for a duration (Δt₁) sufficient to nucleate a plurality of nuclei within the vitreous matrix of the glass-ceramic composition (hereafter referred to as a “post-nucleation glass” article). The second annealing step 200 includes heating the post-nucleation glass article to a second temperature (T2) and holding the post-nucleation glass article at the second temperature for a duration (Δt₂) sufficient to grow crystalline grains within the vitreous matrix and forming a glass-ceramic article. As depicted in FIG. 1, the first temperature T1 is less than a glass transition temperature (Tg) for the glass-ceramic composition and the second temperature is greater than the glass transition temperature for the glass-ceramic composition. It should be understood that while FIG. 1 depicts cooling the glass-ceramic article from the first temperature T1 before heating the glass-ceramic article to the second temperature T2, the glass-ceramic article may be heated directly from the first temperature T1 to the second temperature T2.

The first temperature T1 may be at least 20° C. less than the glass transition temperature Tg for the glass-ceramic composition. For example, the first temperature T1 may be at least 20° C., 25° C., 30° C., 35° C., 40° C., 50° C., 55° C., 65° C., 70° C., 75° C., 80° C., 85° C., 90° C., 95° C., 100° C., 105° C., 110° C., 115° C., 120° C., 125° C., 130° C., 140° C., or 150° C. less than the glass transition temperature Tg for the glass-ceramic composition. In embodiments, the first temperature is between about 20° C. and about 30° C. less than the glass transition temperature Tg. In other embodiments, the first temperature is between about 45° C. and about up 55° C. less than the glass transition temperature Tg. In still other embodiments, the first temperature is between about 70° C. and about 80° C. less than the glass transition temperature Tg. In still yet other embodiments, the first temperature is between about 95° C. and about 105° C. less than the glass transition temperature.

While FIG. 1 graphically depicts the first temperature T1 relative to the glass transition temperature Tg for the glass-ceramic composition, it should be understood that viscosity may be used to define the first temperature T1. That is, the method of forming a glass-ceramic article described herein includes a first annealing step at a first temperature T1 at which the viscosity of the as-formed glass article is greater than 10¹³ poise. For example, the first temperature T1 may be the temperature at which the as-formed glass article has a viscosity greater than 1×10¹³ poise, 2×10¹³ poise, 3×10¹³ poise, 4×10¹³ poise, 5×10¹³ poise, 6×10¹³ poise, 7×10¹³ poise, 8×10¹³ poise, 9×10¹³ poise, or 1×10¹⁴ poise. In embodiments, the first temperature T1 is a temperature at which the as-formed glass article has a viscosity between about 2×10¹³ poise and about 3×10¹³ poise. In other embodiments, the first temperature T1 is a temperature at which the as-formed glass article has a viscosity between about 3×10¹³ poise and about 4×10¹³ poise. In still other embodiments, the first temperature T1 is a temperature at which the as-formed glass article has a viscosity between about 4×10¹³ poise and about 5×10¹³ poise.

The duration Δt₁ of the first annealing step during which the plurality of nuclei are nucleated within the vitreous matrix may be greater than 0.5 hours (h), 1 h, 1.5 h, 2 h, 2.5 h, 3 h, 3.5 h, 4 h, 4.5 h, 5 h, 5.5 h, 6 h, 6.5 h, 7 h, 7.5 h, or 8 h, and less than 12 h, 11.5 h, 11 h, 10.5 h, 10 h, 9.5 h, 9 h, 8.5 h, 8 h, 7.5 h, 7 h, 6.5 h, 6 h, 5.5 h, 5 h, 4.5 h, 4 h, 3.5 h, 3 h, 2.5 h, 2 h, 1.5 h, or 1 h. In embodiments, the duration Δt₁ of the first annealing step is between about 1.5 h and about 2.5 h. In other embodiments, the duration Δt₁ of the first annealing step is between about 2.5 h and about 3.5 h. In still other embodiments, the duration Δt₁ of the first annealing step is between about 3.5 h and about 4.5 h.

The second temperature T2 may be at least 25° C. greater than the glass transition temperature Tg for the glass-ceramic composition. For example, the second temperature T2 may be at least 25° C., 50° C., 75° C., 100° C., 125° C., 150° C., 175° C., 200° C., 225° C., 250° C., 275° C., or 300° C. greater than the glass transition temperature Tg for the glass-ceramic composition. In embodiments, the second temperature is between about 100° C. and about 150° C. greater than the glass transition temperature Tg. In other embodiments, the second temperature is between about 150° C. and about up 200° C. greater than the glass transition temperature Tg. In still other embodiments, the second temperature is between about 200° C. and about 250° C. greater than the glass transition temperature Tg. In still yet other embodiments, the second temperature is between about 250° C. and about 300° C. less than the glass transition temperature Tg.

Similar to the use of viscosity to define the first temperature T1 of the first annealing step 100, viscosity may be used to define the second temperature T2 of the second annealing step 200. That is, the process of forming a glass-ceramic article described herein includes a second annealing step at a second temperature T2 at which the viscosity of the post-nucleation glass article is less than 10¹³ poise. For example, the second temperature T2 may be a temperature at which the viscosity of the post-nucleation glass article is less than 1×10¹³ poise, 9×10¹² poise, 8×10¹² poise, 7×10¹² poise, 6×10¹² poise, 5×10¹² poise, 4×10¹² poise, 3×10¹² poise, 2×10¹² poise, or 1×10¹² poise. In embodiments, the second temperature T2 is a temperature at which the post-nucleation glass article has a viscosity between about 9×10¹² poise and about 8×10¹² poise. In other embodiments, the second temperature T2 is a temperature at which the post-nucleation glass article has a viscosity between about 8×10¹² poise and about 7×10¹² poise. In still other embodiments, the second temperature T2 is a temperature at which the post-nucleation glass article has a viscosity between about 7×10¹² poise and about 6×10¹² poise.

The duration Δt₂ of the second annealing step may be greater 2 h, 2.5 h, 3 h, 3.5 h, 4 h, 4.5 h, 5 h, 5.5 h, 6 h, 6.5 h, 7 h, 7.5 h, or 8 h, and less than 12 h, 11.5 h, 11 h, 10.5 h, 10 h, 9.5 h, 9 h, 8.5 h, 8 h, 7.5 h, 7 h, 6.5 h, 6 h, 5.5 h, 5 h, 4.5 h, 4 h, 3.5 h, and 3 h. In embodiments, the duration Δt₂ of the second annealing step is between about 2.5 h and about 3.5 h. In other embodiments, the duration Δt₂ of the second annealing step is between about 3.5 h and about 4.5 h. In still other embodiments, the duration Δt₂ of the second annealing step is between about 4.5 h and about 5.5 h.

The method to form a glass-ceramic articles as embodied above may be used to form any appropriate glass-ceramic article. Non-limiting examples up of articles formed by embodiments of the method include stove-top surfaces, cookware, optical wave guides, telescope mirrors, bone prosthesis, dental restorations, decorative furnishings and art work. Various embodiments will be further clarified by the following examples.

### EXAMPLES

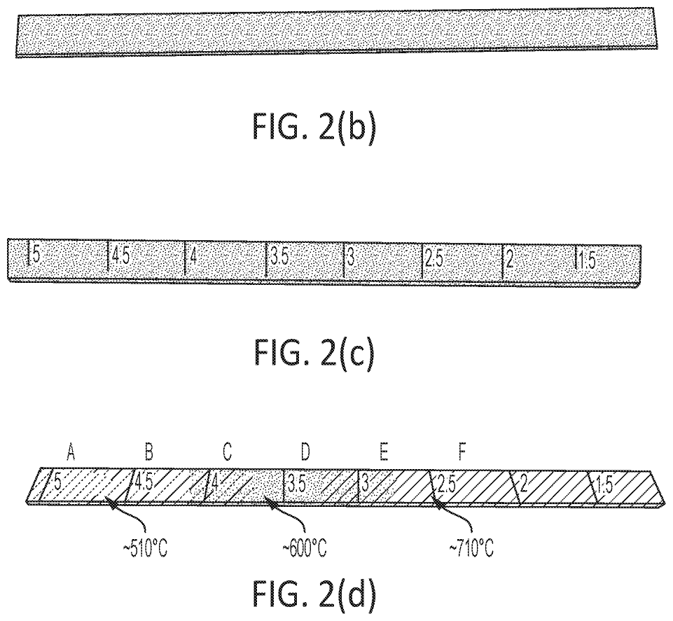

Referring now to FIGS. 1 and 2(a)-2(d), an example of a glass-ceramic article formed using a first annealing step 100 and a second annealing step 200 is shown. Particularly, FIG. 2(a) graphically depicts a temperature profile for a gradient furnace used to anneal an as-formed glass-ceramic strip at a plurality of different first temperatures. As shown by the temperature profile in FIG. 2(a), the gradient furnace had a maximum temperature of about 800° C. and a minimum temperature of about 450° C. A photograph of the as-formed glass-ceramic strip is shown in FIG. 2(b) and has a dark gray appearance. The as-formed glass strip had a glass-ceramic composition, comprising Li₂O, Al₂O₃, SiO₂, and Fe₂O₃. The glass transition temperature for the glass-ceramic composition was about 607° C. The as-formed glass strip was annealed in the gradient furnace having the temperature profile shown in FIG. 2(a) for a duration Δt₁ of 2.25 h to form a post-nucleation glass strip. A photograph of the post-nucleation glass-ceramic strip is shown in FIG. 2(c). The post-nucleation glass strip has a dark gray appearance similar to the as-formed glass strip shown in FIG. 2(b).

The post-nucleation glass strip was isothermally annealed at a second temperature T2 of 800° C. for a duration Δt₂ of 4 h to form a glass-ceramic strip. A photograph of the glass-ceramic strip is shown in FIG. 2(d). Positions along the length of the glass-ceramic strip where the first temperature T1 was 510° C., 600° C., and 710° C. during the first annealing step 100 are shown in FIG. 2(d). Also, the glass-ceramic strip shown in FIG. 2(b) exhibits a range of colors along its length. Particularly, the glass-ceramic strip exhibits a dark gray to dark blue color at the far left end (labeled ‘A’) where the as-formed glass strip was annealed during the first annealing step 100 at a first temperature T1 of about 456° C. The glass-ceramic strip exhibits a light violet color at the location of the glass-ceramic strip where the first temperature T1 was about 510° C. (also labeled ‘B’), a white/light blue color at location ‘C’, a light blue color at the location where the first temperature T1 was about 600° C. (also labeled ‘D’), a light blue/white color at location ‘E’, and a transition from a light blue color to a dark gray color at the location where the first temperature T1 was about 710° C. (also labeled ‘F’). It should be understood that the range of colors from location A to location F is the result of nucleation of a plurality of nuclei within the vitreous matrix of the as-formed glass strip during the first annealing step 100 at the range of temperatures shown in the temperature profile in FIG. 2(a) and growth of crystalline grains within the vitreous matrix of the post-nucleation glass strip during the second annealing step 200 at 800° C. For example, the color at the location where the first temperature T1 was about 510° C. (location B) demonstrates that nucleation of a plurality of nuclei occurred at a first temperature T1 that was about 100° C. less than the glass transition temperature Tg of about 607° C.

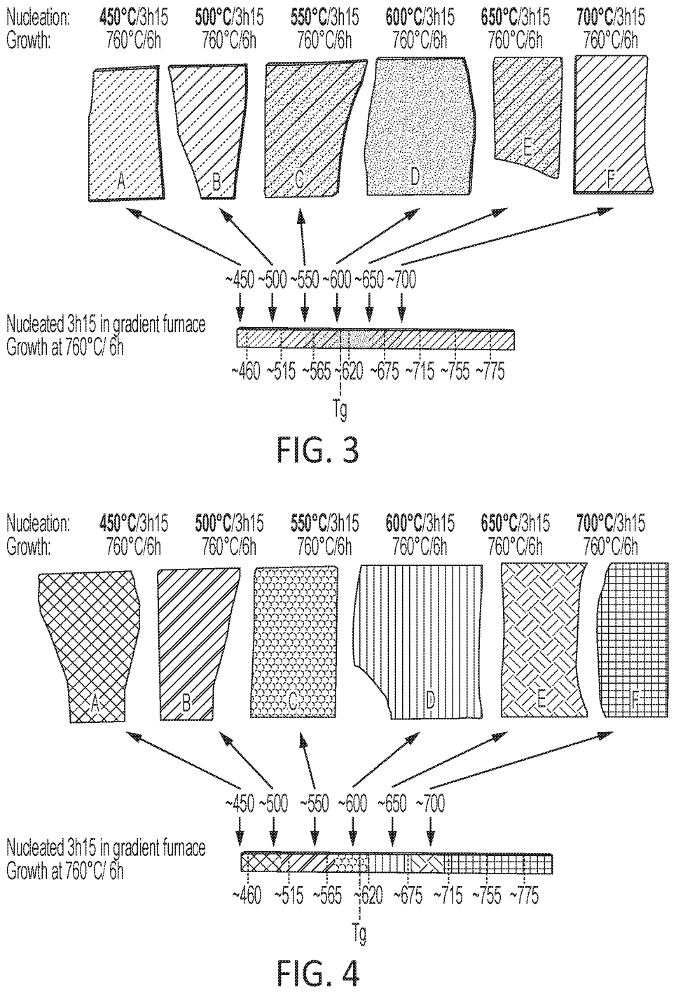

Referring now to FIGS. 1 and 3, examples of glass-ceramic articles formed using a method with a first annealing step 100 and a second annealing step 200 as depicted in FIG. 1 are shown in FIG. 3. Particularly, a glass-ceramic strip shown at the bottom of the photograph in FIG. 3 was formed by annealing an as-formed glass strip in a gradient furnace with a temperature profile as described above with reference to FIG. 2(a) (first annealing step 100) to form a post-nucleation glass strip, and then isothermally annealing the post-nucleation glass strip at 760° C. for 6 h (second annealing step 200). Also, glass-ceramic panels (labeled A-F) shown in FIG. 3 were formed by isothermally annealing as-formed glass panels at different first temperatures T1 in a first annealing step 100 to form post-nucleation glass panels and isothermally annealing the post-nucleation glass panels at a second temperature T2 of 760° C. in a second annealing step 200. The glass-ceramic strip and the glass-ceramic panels shown in FIG. 3 had a glass-ceramic composition comprising Li₂O, Al₂O₃, SiO₂, and Fe₂O₃. The glass transition temperature for the glass-ceramic composition was about 608° C. An as-formed glass strip (not shown) was annealed in the gradient furnace having the temperature profile shown in FIG. 2(a) for a duration Δt₁ of 3.25 h to form a post-nucleation glass strip (not shown). The post-nucleation glass strip was isothermally annealed at a second temperature T2 of 760° C. for a duration At2 of 6 h to form the glass-ceramic strip shown in FIG. 3.

Positions along the length of the glass-ceramic strip where the first temperature T1 during the first annealing step 100 was about 450° C., 460° C., 500° C., 515° C., 550° C., 565° C., 600° C., 620° C., 650° C., 675° C., 700° C., 715° C., 755° C. and 775° C. are shown in FIG. 3. Also, glass-ceramic panels A-E formed by isothermally annealing as-formed glass panels in the first annealing step 100 and the second annealing step 200 are shown in FIG. 3. Particularly, glass-ceramic panel A was formed by isothermal annealing an as-formed glass panel at a first temperature T1 of 450° C. for a duration Δt₁ of 3.25 h to form a post-nucleation glass panel, followed by isothermal annealing the post-nucleation glass panel at a second temperature of 760° C. for 6 h. Glass-ceramic panel B was formed by isothermal annealing an as-formed glass panel at a first temperature T1 of 500° C. for a duration Δt₁ of 3.25 h to form a post-nucleation glass panel, followed by isothermal annealing the post-nucleation glass panel at the second temperature of 760° C. for 6 h. Glass-ceramic panel C was formed by isothermal annealing an as-formed glass panel at a first temperature T1 of 550° C. for a duration Δt₁ of 3.25 h to form a post-nucleation glass panel, followed by isothermal annealing the post-nucleation glass panel at the second temperature of 760° C. for 6 h. Glass-ceramic panel D was formed by isothermal annealing an as-formed glass panel at a first temperature T1 of 600° C. for a duration Δt₁ of 3.25 h to form a post-nucleation glass panel, followed by isothermal annealing the post-nucleation glass panel at the second temperature of 760° C. for 6 h. Glass-ceramic panel E was formed by isothermal annealing an as-formed glass panel at a first temperature T1 of 650° C. for a duration Δt₁ of 3.25 h to form a post-nucleation glass panel, followed by isothermal annealing the post-nucleation glass panel at the second temperature of 760° C. for 6 h. Glass-ceramic panel F was formed by isothermal annealing an as-formed glass panel at a first temperature T1 of 700° C. for a duration Δt₁ of 3.25 h to form a post-nucleation glass panel, followed by isothermal annealing the post-nucleation glass panel at the second temperature of 760° C. for 6 h.

The glass-ceramic panel A exhibited a light tan color, glass-ceramic panel B exhibited a light gray color, glass-ceramic panel C exhibited a frosty white color, glass-ceramic panel D exhibited a frosty white/light green color, glass-ceramic panel E exhibited a frosty white/light green color, and glass-ceramic panel F exhibited a dark brown/gray color. It should be understood that the range of colors exhibited by glass-ceramic panels A-F is the result of nucleation of a plurality of nuclei within the vitreous matrix of the as-formed glass strip during the first annealing step 100 at the range of temperatures discussed above and growth of crystalline grains during the second annealing step 200 at 760° C. For example, the color for the glass-ceramic panels B and C demonstrates that nuclei were nucleated in the as-formed glass panels at first temperatures T1 of 500° C. and 550° C., respectively, which is 108° C. and 58° C. less than the glass transition temperature Tg of about 608° C.

Referring now to FIGS. 1 and 4, examples of glass-ceramic articles formed using a method with a first annealing step 100 and a second annealing step 200 as depicted in FIG. 1 are shown in FIG. 4. Particularly, a glass-ceramic strip shown at the bottom of the photograph in FIG. 4 was formed by annealing an as-formed glass strip in a gradient furnace with a temperature profile as described above with reference to FIG. 2(a) (first annealing step 100) to form a post-nucleation glass strip, and then isothermally annealing the post-nucleation glass strip at 760° C. for 6 h (second annealing step 200). Also, glass-ceramic panels (labeled A-F) shown in FIG. 4 were formed by isothermally annealing as-formed glass panels at different first temperatures T1 in a first annealing step 100 to form post-nucleation glass panels and isothermally annealing the post-nucleation glass panels at a second temperature T2 of 760° C. in a second annealing step 200. The glass-ceramic strip and the glass-ceramic panels shown in FIG. 4 had a glass-ceramic composition comprising Li₂O, Al₂O₃, SiO₂, and Fe₂O₃. The glass transition temperature for the glass-ceramic composition was about 605° C. An as-formed glass strip (not shown) was annealed in the gradient furnace having the temperature profile shown in FIG. 2(a) for a duration Δt₁ of 3.25 h to form a post-nucleation glass strip (not shown). The post-nucleation glass strip was isothermally annealed at a second temperature T2 of 760° C. for a duration Δt₂ of 6 h to form the glass-ceramic strip shown in FIG. 4.

Positions along the length of the glass-ceramic strip where the first temperature T1 during the first annealing step 100 was about 450° C., 460° C., 500° C., 515° C., 550° C., 565° C., 600° C., 620° C., 650° C., 675° C., 700° C., 715° C., 755° C. and 775° C. are shown in FIG. 4. Also, glass-ceramic panels A-E formed by isothermally annealing as-formed glass panels in the first annealing step 100 and the second annealing step 200 are shown in FIG. 4. Particularly, glass-ceramic panel A was formed by isothermal annealing an as-formed glass panel at a first temperature T1 of 450° C. for a duration Δt₁ of 3.25 h to form a post-nucleation glass panel, followed by isothermal annealing the post-nucleation glass panel at a second temperature of 760° C. for 6 h. Glass-ceramic panel B was formed by isothermal annealing an as-formed glass panel at a first temperature T1 of 500° C. for a duration Δt₁ of 3.25 h to form a post-nucleation glass panel, followed by isothermal annealing the post-nucleation glass panel at the second temperature of 760° C. for 6 h. Glass-ceramic panel C was formed by isothermal annealing an as-formed glass panel at a first temperature T1 of 550° C. for a duration Δt₁ of 3.25 h to form a post-nucleation glass panel, followed by isothermal annealing the post-nucleation glass panel at the second temperature of 760° C. for 6 h. Glass-ceramic panel D was formed by isothermal annealing an as-formed glass panel at a first temperature T1 of 600° C. for a duration Δt₁ of 3.25 h to form a post-nucleation glass panel, followed by isothermal annealing the post-nucleation glass panel at the second temperature of 760° C. for 6 h. Glass-ceramic panel E was formed by isothermal annealing an as-formed glass panel at a first temperature T1 of 650° C. for a duration Δt₁ of 3.25 h to form a post-nucleation glass panel, followed by isothermal annealing the post-nucleation glass panel at the second temperature of 760° C. for 6 h. Glass-ceramic panel F was formed by isothermal annealing an as-formed glass panel at a first temperature T1 of 700° C. for a duration Δt₁ of 3.25 h to form a post-nucleation glass panel, followed by isothermal annealing the post-nucleation glass panel at the second temperature of 760° C. for 6 h.

The glass-ceramic panel A exhibited a grey color, glass-ceramic panel B exhibited a blue color, glass-ceramic panel C exhibited a light green color, glass-ceramic panel D exhibited a blue color, glass-ceramic panel E exhibited a green color, and glass-ceramic panel F exhibited a dark brown color. It should be understood that the range of colors exhibited by glass-ceramic panels A-F is the result of nucleation of a plurality of nuclei within the vitreous matrix of the as-formed glass strip during the first annealing step 100 at the range of temperatures discussed above and growth of crystalline grains during the second annealing step 200 at 760° C. For example, the color for the glass-ceramic panels B and C demonstrates that nuclei were nucleated in the as-formed glass panels at first temperatures T1 of 500° C. and 550° C., respectively, which is 105° C. and 55° C. less than the glass transition temperature Tg of about 605° C.

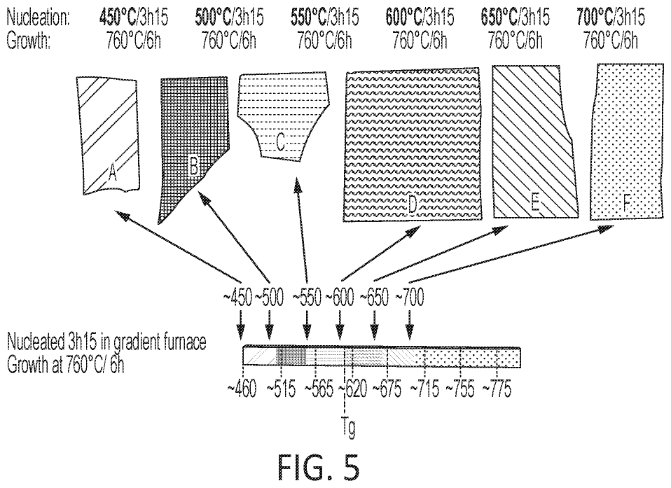

Referring now to FIGS. 1 and 5, examples of glass-ceramic articles formed using a method with a first annealing step 100 and a second annealing step 200 as depicted in FIG. 1 are shown in FIG. 5. Particularly, a glass-ceramic strip shown at the bottom of the photograph in FIG. 5 was formed by annealing an as-formed glass strip in a gradient furnace with a temperature profile as described above with reference to FIG. 2(a) (first annealing step 100) to form a post-nucleation glass strip, and then isothermally annealing the post-nucleation glass strip at 760° C. for 6 h (second annealing step 200). Also, glass-ceramic panels (labeled A-F) shown in FIG. 5 were formed by isothermally annealing as-formed glass panels at different first temperatures T1 in a first annealing step 100 to form post-nucleation glass panels and isothermally annealing the post-nucleation glass panels at a second temperature T2 of 760° C. in a second annealing step 200. The glass-ceramic strip and the glass-ceramic panels shown in FIG. 5 had a glass-ceramic composition comprising Li₂O, Al₂O₃, SiO₂, and Fe₂O₃. The glass transition temperature for the glass-ceramic composition was about 608° C. An as-formed glass strip (not shown) was annealed in the gradient furnace having the temperature profile shown in FIG. 2(a) for a duration Δt₁ of 3.25 h to form a post-nucleation glass strip (not shown). The post-nucleation glass strip was isothermally annealed at a second temperature T2 of 760° C. for a duration Δt₂ of 6 h to form the glass-ceramic strip shown in FIG. 5.

Positions along the length of the glass-ceramic strip where the first temperature T1 during the first annealing step 100 was about 450° C., 460° C., 500° C., 515° C., 550° C., 565° C., 600° C., 620° C., 650° C., 675° C., 700° C., 715° C., 755° C. and 775° C. are labeled and shown in FIG. 5. Also, glass-ceramic panels A-E formed by isothermally annealing as-formed glass panels in the first annealing step 100 and the second annealing step 200 are shown in FIG. 5. Particularly, glass-ceramic panel A was formed by isothermal annealing an as-formed glass panel at a first temperature T1 of 450° C. for a duration Δt₁ of 3.25 h to form a post-nucleation glass panel, followed by isothermal annealing the post-nucleation glass panel at a second temperature of 760° C. for 6 h. Glass-ceramic panel B was formed by isothermal annealing an as-formed glass panel at a first temperature T1 of 500° C. for a duration Δt₁ of 3.25 h to form a post-nucleation glass panel, followed by isothermal annealing the post-nucleation glass panel at the second temperature of 760° C. for 6 h. Glass-ceramic panel C was formed by isothermal annealing an as-formed glass panel at a first temperature T1 of 550° C. for a duration Δt₁ of 3.25 h to form a post-nucleation glass panel, followed by isothermal annealing the post-nucleation glass panel at the second temperature of 760° C. for 6 h. Glass-ceramic panel D was formed by isothermal annealing an as-formed glass panel at a first temperature T1 of 600° C. for a duration Δt₁ of 3.25 h to form a post-nucleation glass panel, followed by isothermal annealing the post-nucleation glass panel at the second temperature of 760° C. for 6 h. Glass-ceramic panel E was formed by isothermal annealing an as-formed glass panel at a first temperature T1 of 650° C. for a duration Δt₁ of 3.25 h to form a post-nucleation glass panel, followed by isothermal annealing the post-nucleation glass panel at the second temperature of 760° C. for 6 h. Glass-ceramic panel F was formed by isothermal annealing an as-formed glass panel at a first temperature T1 of 700° C. for a duration Δt₁ of 3.25 h to form a post-nucleation glass panel, followed by isothermal annealing the post-nucleation glass panel at the second temperature of 760° C. for 6 h.

The glass-ceramic panel A exhibited a blue color, glass-ceramic panel B exhibited a blue color, glass-ceramic panel C exhibited a light green color, glass-ceramic panel D exhibited a blue color, glass-ceramic panel E exhibited a light green/blue color, and glass-ceramic panel F exhibited a dark blue color. It should be understood that the range of colors exhibited by glass-ceramic panels A-F is the result of nucleation of a plurality of nuclei within the vitreous matrix of the as-formed glass strip during the first annealing step 100 at the range of temperatures discussed above and growth of crystalline grains during the second annealing step 200 at 760° C. For example, the change in color for the glass-ceramic panels A, B and C demonstrates that nuclei were nucleated in the as-formed glass panels at first temperatures T1 of 450° C., 500° C. and 550° C., respectively, which is 158° C., 108° C. and 58° C., respectively, less than the glass transition temperature Tg of about 608° C.

Because the method for forming the glass-ceramic articles described herein uses a first annealing step with a first temperature that is less than the glass transition temperature of the glass-ceramic articles, less energy is used to form glass-ceramic articles compared to methods that use a first annealing step with a first temperature that is greater than the glass transition temperature. Also, the method for forming glass-ceramic articles described herein provides colors for glass-ceramic compositions that cannot be obtained using a first annealing step with a first temperature that is greater than the glass transition temperature. Particularly, glass-ceramic compositions with relatively high iron (Fe) contents may be used to form white glass-ceramic articles. The reduction in energy to form glass-ceramic articles and the use of glass-ceramic compositions with relatively high Fe content both result in reduced cost in the manufacturing of glass-ceramic articles using the method described herein.

It will be apparent to those skilled in the art that various modifications and variations can be made to the embodiments described herein without departing from the spirit and scope of the claimed subject matter. Thus, it is intended that the specification cover the modifications and variations of the various embodiments described herein provided such modification and variations come within the scope of the appended claims and their equivalents.

1. A method for making a glass-ceramic article from a glass-ceramic composition, the process comprising:
annealing an as-formed glass article comprising a glass-ceramic composition at a first temperature for a duration sufficient to nucleate a plurality of nuclei within a vitreous matrix of the glass-ceramic composition and forming a post-nucleation glass article; and
annealing the post-nucleation glass article at a second temperature for a duration sufficient to grow crystalline grains within the vitreous matrix of the post-nucleation glass article and forming a glass-ceramic article;
wherein the first temperature is less than a glass transition temperature for the glass-ceramic composition and the second temperature is greater than the glass transition temperature for the glass-ceramic composition.

2. The method of claim 1, wherein the first temperature is at least 25° C. less than the glass transition temperature for the glass-ceramic composition.

3. The method of claim 2, wherein the first temperature is at least 50° C. less than the glass transition temperature for the glass-ceramic composition.

4. The method of claim 3, wherein the first temperature is at least 100° C. less than the glass transition temperature for the glass-ceramic composition.

5. The method of claim 1, wherein a viscosity of the glass-ceramic composition is equal to or greater than 10¹³ poise at the glass transition temperature.

6. The method of any of claim 1, wherein the glass-ceramic composition comprises a chemical composition comprising Li₂O, Al₂O₃, SiO₂, and Fe₂O₃, and has a glass transition temperature between about 590° C. and about 610° C.

7. The method of claim 6, wherein the first temperature is less than 550° C.

8. The method of claim 7, wherein the first temperature is less than 500° C.

9. The method of claim 8, wherein the first temperature is less than 450° C.

10. The method of claim 1, wherein the as-formed glass article is annealed at the first temperature for less than 8 hours.

11. The method of claim 10, wherein the as-formed glass article is annealed at the first temperature for less than 6 hours.

12. The method of claim 1, wherein a viscosity of the as-formed glass article at the first temperature is equal to or greater than 1.0×10¹³ poise and the viscosity of the post-nucleation glass article at the second temperature is less than 1.0×10¹³ poise.

13. The method of claim 12, wherein the viscosity of the as-formed glass article at the first temperature is greater than or equal to 5.0×10¹³ poise.

14. The method of claim 13, wherein the viscosity of the as-formed glass article at the first temperature is greater than or equal to 1.0×10¹⁴ poise.

15. A glass-ceramic article prepared by a process comprising:
annealing an as-formed glass article formed from a glass-ceramic composition comprising a chemical composition comprising Li₂O, Al₂O₃, SiO₂, and Fe₂O₃ at a first temperature such that a plurality of nuclei nucleate within a vitreous matrix of the as-formed glass article and form a post-nucleation glass article;
annealing the post-nucleation glass article at a second temperature such that crystalline grains grow within the vitreous matrix of the post-nucleation glass article and form the glass-ceramic glass article;
wherein the first temperature is less than a glass transition temperature for the glass-ceramic composition and the second temperature is greater than the glass transition temperature for the glass-ceramic composition.

16. A method for making a glass-ceramic article from a glass-ceramic composition, the process comprising:
annealing an as-formed glass article comprising a glass-ceramic composition at a first temperature for a duration sufficient to nucleate a plurality of nuclei within a vitreous matrix of the glass-ceramic composition and forming a post-nucleation glass article; and
annealing the post-nucleation glass article at a second temperature for a duration sufficient to grow crystalline grains within the vitreous matrix of the post-nucleation glass article and forming a glass-ceramic article;
wherein the first temperature is less than a glass transition temperature for the glass-ceramic composition and the second temperature is greater than the glass transition temperature for the glass-ceramic composition;
wherein the glass-ceramic composition comprises a chemical composition comprising Li₂O, Al₂O₃, SiO₂, and Fe₂O₃, and has a glass transition temperature between about 590° C. and about 610° C.;
wherein a viscosity of the as-formed glass article at the first temperature is equal to or greater than 1.0×10¹³ poise and the viscosity of the post-nucleation glass article at the second temperature is less than 1.0×10¹³ poise.

17. The method of claim 16, wherein the first temperature is at least 25° C. less than the glass transition temperature for the glass-ceramic composition.

18. The method of claim 17, wherein the as-formed glass article is annealed at the first temperature for less than 8 hours.

19. The method of claim 18, wherein the first temperature is at least 100° C. less than the glass transition temperature for the glass-ceramic composition.

20. The method of claim 19, wherein the first temperature is less than 550° C.
